(19) United States
(12) Patent Application Publication
(10) Pub. No.: US 2021/0285582 A1
(43) Pub. Date: Sep. 16, 2021

(54) INJECTION MOLDED HOSE CONNECTIONS FOR BLOW MOLDED TUBES

(71) Applicant: ContiTech Techno-Chemie GmbH, Karben (DE)

(72) Inventor: Joseph Peter Schultz, Dover, NH (US)

(73) Assignee: ContiTech Techno-Chemie GmbH, Karben (DE)

(21) Appl. No.: 16/813,783

(22) Filed: Mar. 10, 2020

(51) Int. Cl. F16L 33/24; B29C 45/14; F16L 11/08; B29C 45/00

(52) U.S. Cl. CPC F16L 33/24; B29C 45/14598; B29L 2023/005; B29C 45/0005; B29C 2045/1445; F16L 11/08

(57) ABSTRACT

A hose cell assembly system for fabricating hoses with integrated hose connections is disclosed. The hose cell assembly system includes an injection mold; and an injection molding machine configured to form an integrated hose connection onto an end of a plastic tubing using an injection molding process using the injection mold, where the plastic tubing is formed by a blow molding process.

### FIELD

The disclosure generally relates to fluid conveyance, molded tubes and hose connections.

### BACKGROUND

Blow molding is a manufacturing process by which plastic parts are formed and can be joined together.

There blow molding process typically begins with a melting down of plastic and forming it into a preform or parison. The preform or parison is clamped into a mold and air is blown into it. Air pressure causes plastic to expand or move to match the mold. The formed plastic is permitted to cool and the part is ejected from the mold.

The blow molding process is often used for forming fittings to hoses and the like. In one example, the fittings are formed using a steel band and milling. However, this technique can result in complications due to varied thermal expansion of the steel band and plastic material. These complications including producing unwanted debris.

What is needed are techniques to facilitate formation of fittings and the like for fluid and/or air conveyance.

### BRIEF DESCRIPTION OF THE DRAWINGS

FIG. 1 is a diagram illustrating molded hose connection formation assembly 100 for a formation cell/system in accordance with one or more embodiments.

FIG. 2 is a diagram illustrating a hose assembly 200 in accordance with one or more embodiments.

FIG. 3 is a diagram illustrating a plastic tube production cell 300 in accordance with one or more embodiments.

FIG. 4 is a diagram illustrating a two cavity injection mold 400 utilized for injection molding in accordance with one or more embodiments.

FIG. 5A is a diagram illustrating a tube hose 500 with injection molded hose ends in accordance with one or more embodiments.

FIG. 5B is a diagram illustrating a portion of the tube hose 500 in accordance with one or more embodiments.

FIG. 5C is a diagram illustrating another portion of the tube hose 500 in accordance with one or more embodiments

FIG. 6 is a flow diagram illustrating a method 600 of fabricating a tube assembly having integrated hose connections.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

It is appreciated that current production techniques include a plastic tube produced by a blow molding process and an internal steel band. The plastic tube is formed in the blow molding process with an integral spigot for connecting hoses. The inner portion of the tube at the spigot must then be post processed by milling a hole of required diameter and depth to allow the metal crush ring band to be inserted into the tube end. This prevents distortion due to creep of the material under temperature and pressure from hose clamps, which causes failures by leaking, hose disengagement and the like.

It is appreciated that the required milling process creates significant plastic debris, which then enters the body of the plastic tube. While attempts are made to remove this plastic debris, it often at least partially remains. Sometimes this removal proves to be extraordinarily difficult, and causing quality and warranty issues with the Customers due to excessive contamination. Further, the inner metal crush ring band, which is fitted to the inner bore for the spigot, may sometimes dislodge or fall out due to different coefficients of thermal expansion between the plastic tube and the metal ring, also causing quality issues.

It is also appreciated that the manufacturing process of the milling, the contaminant extraction and cleaning, and the process to insert the metal crush ring band are complicated and require precision in the tooling and the placement of the parts, in order to ensure high product quality.

One or more embodiments are disclosed that facilitate formation of a spigot with a plastic tube that mitigate the above issues. Further, the embodiments provide elimination of the milling process and elimination of the metal crush ring band during formation of the spigot. The embodiments generally reduce complexity and mitigate quality and warranty issues related to the contamination and the like. Elimination of the metal crush ring band reduces the overall complexity of the part, and reduces the purchased parts inventory. Further, elimination of the metal crush ring band eliminates the potential for ring movement/fall out and the like.

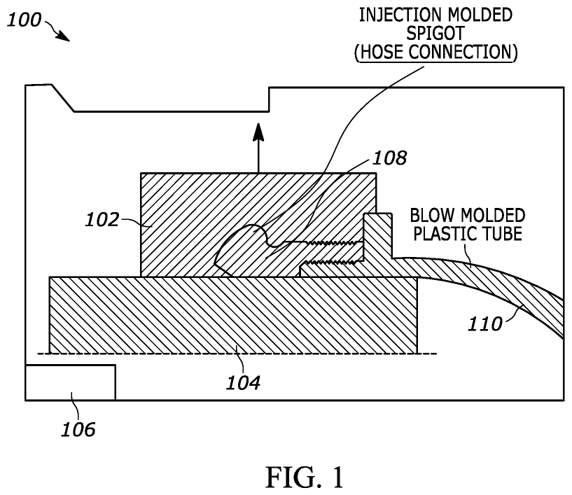

FIG. 1 is a diagram illustrating molded hose connection formation assembly 100 for a formation cell/system in accordance with one or more embodiments. It is appreciated that the assembly 100 is provided for illustrative purposes and that suitable variations are contemplated.

The assembly or apparatus 100 includes a blow molded plastic tube 110, an injection molded hose connection 108, an upper mold 102, a lower mold 104 and a support 106.

The plastic tube 110 is produced by blow molding. Typically, the blow molding process uses a plastic material having a glass fiber content of less than or equal about 25 percent glass fiber.

The blow molding process typically begins with a melting down of plastic and forming it into a preform or parison. The preform or parison is clamped into a mold and air is blown into it. Air pressure causes plastic to expand or move to match the mold. The formed plastic is permitted to cool and the tube 110 is ejected from the mold.

The hose connection 108 is formed by directly overmolding the hose connection 108 over an end of the tube 110 using an injection molding process and material. The hose connection 108 can also be referred to as a spigot or hose barb portion. The injection molding uses an injection material that has greater than or equal to 35 percent of glass fiber. The injection material is selected to increase strength and rigidity of the material. The percentage of glass fiber material used in the injection material mitigates the need for a separate steel band to prevent material creep and deformation and the hose connection 108 can be formed directly to the end of the tube 110. The glass fiber includes short glass fiber and long fiber reinforced thermoplastics (LFRTs)

It is appreciated that the injection material can include other suitable filler materials instead of or in addition to the glass fiber. The other materials can also be selected for strength, rigidity and the like of the injection material.

Additionally, it is appreciated that directly forming the hose connection 108 to the tube 110 eliminates the need to mill the inner bore of the tube to fit the metal band, and this eliminates the possibility for the creation of debris and mitigates related issues, described above.

A blow molding machine (not shown) is used to produce the plastic tube 110 prior to formation with the hose connection 108. In one example, hose connections, such as the hose connection 108, are molded onto both ends of the plastic tube using an injection molding machine and an injection mold tool with suitable cavitation to mold all hose connections in a «musical chairs» methodology.

A conveyance robot can be used to convey the blow molded tube from the blow molding machine, to a cooling station, to the required positions in the injection molding process, and then finally to a conveyor belt to direct the finished part to a collection area.

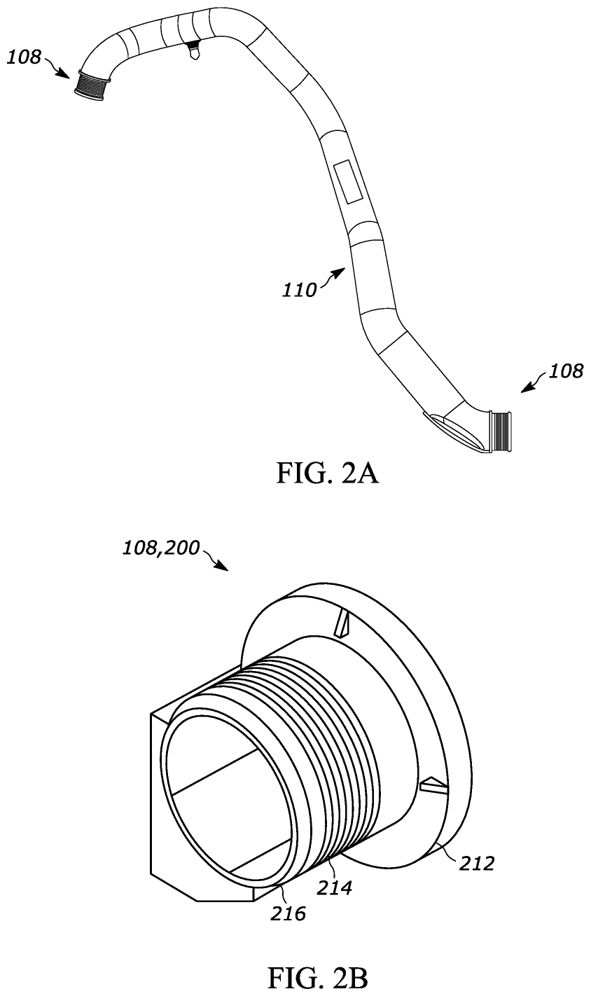

FIG. 2 is a diagram illustrating a hose assembly 200 in accordance with one or more embodiments. It is appreciated that the assembly 200 is provided for illustrative purposes and that suitable variations are contemplated.

The assembly 200 includes a blow molded plastic tube 110 and injection molded hose connections 108.

One of the hose connections is shown in greater deal and includes an edge 216, barbs 214 and a shoulder 212. The edge 216 and barb 214 collective form a barb profile. this profile generally determines how much a hose or tube stretches when pushed over the barb. This determines how easy or difficult it is to install the hose or tube to the hose connection. This stretch can be indicated as a percentage of the hose/tube 110 inner diameter. A higher expansion percentage causes barb connections to seal and hold against higher pressure.

Other design considerations for the hose connection include the number of barbs, depth of the barb, spacing of barb ridges, sharpness of barb gripping edges, slope or angle of the barb (e.g., high or low).

The design and/or features of the barb portion of the hose connection are formed during the injection molding process.

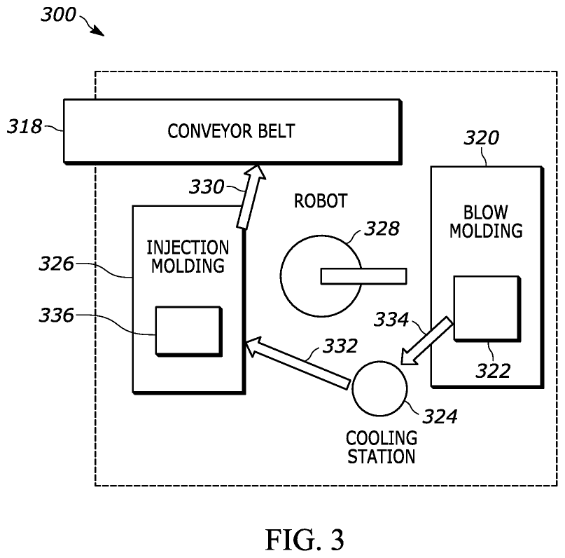

FIG. 3 is a diagram illustrating a plastic tube production cell 300 in accordance with one or more embodiments. It is appreciated that the cell/system 300 is provided for illustrative purposes and that suitable variations are contemplated. The cell 300 uses blow molding and injection molding.

The cell 300 includes a conveyor belt 318, a blow molding machine 320, a cooling station 324, an injection molding machine 326 and a conveyance robot 328.

The robot 328 is configured to remove components at various stages of fabrication to and from the various elements of the cell 300. The robot 328 comprises circuitry to control its operation and perform tasks.

The plastic tube 110 is formed by the blow molding machine 320. A blow molding mold 322 is generally utilized during the process. The blow molding process and machine 320 uses a plastic material having a glass fiber content of less than or equal about 25 percent glass fiber. The blow molding machine 320 includes circuitry for controlling the blow molding process, material selection and the like.

The blow molding begins with a melting down of plastic and forming it into a preform or parison. The preform or parison is clamped into the mold 322 and air is blown into it. Air pressure causes plastic to expand or move to match the mold 322. The formed plastic is permitted to cool and the tube 110 is ejected from the mold 322.

The robot 328 is configured to move the tube 110 from the machine 320 to the cooling station 324 as shown at 334.

Once cooled to a suitable temperature, the robot 328 is configured to move the plastic tube 110 from the cooling station 324 to the injection molding machine 326 as shown at 332.

One or more hose connections 108 are formed by the injection molding machine 326 by directly overmolding the hose connections 108 over an end of the tube 110 using an injection molding process and material. The injection molding machine 326 uses an injection mold 336.

The injection molding machine 326 includes circuitry for controlling the injection molding process, material selection, and the like.

In one example, the injection molding uses an injection material that has greater than or equal to 35 percent of glass fiber. The injection material is selected to increase strength and rigidity of the material. The percentage of glass fiber material used in the injection material mitigates the need for a separate steel band to prevent material creep and deformation and the hose connection 108 can be formed directly to the end of the tube 110.

Additionally, it is appreciated that directly forming the hose connection 108 to the tube 110 eliminates the need to mill the inner bore of the tube to fit the metal band, and this eliminates the possibility for the creation of debris and mitigates related issues, described above.

The conveyance robot 328 is configured to convey the finished tube 110 with integrated hose ends 108 to the conveyor belt 318 for transport of the finished assembly to other areas, such as packaging and the like.

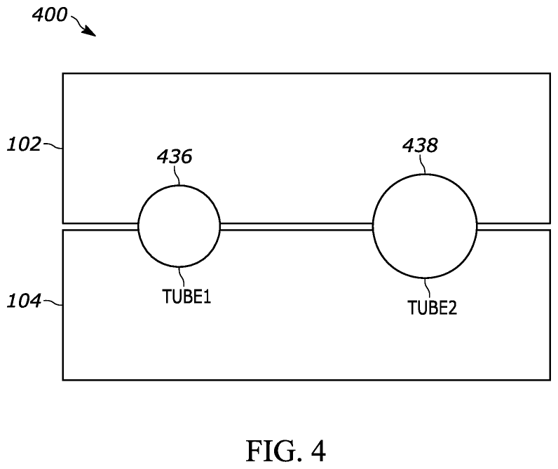

FIG. 4 is a diagram illustrating a two cavity injection mold 400 utilized for injection molding in accordance with one or more embodiments. It is appreciated that the mold 400 is provided for illustrative purposes and that suitable variations are contemplated.

The mold 400 can be used in the cell 300 for fabrication of plastic tubing assemblies having integrated hose connections.

The mold 400 includes an upper part 102 and a lower part 104, also shown in FIG. 1. The mold 400 additionally has a first cavity 436 and a second cavity 438.

At the injection molding machine, the robot transfers 2 parts per time or fabrication to injection mold the hose connections 108 to the tube 110.

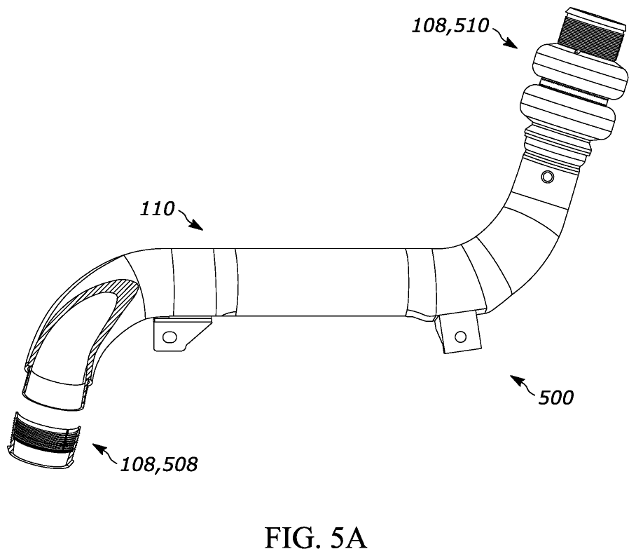

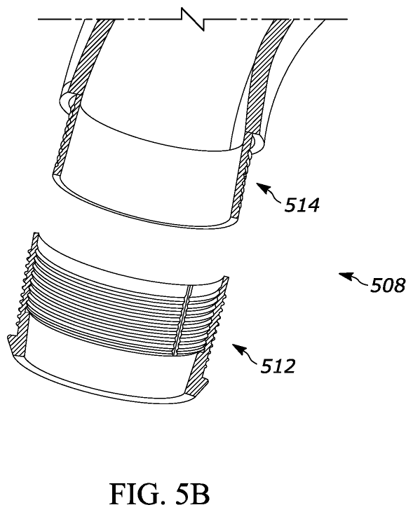

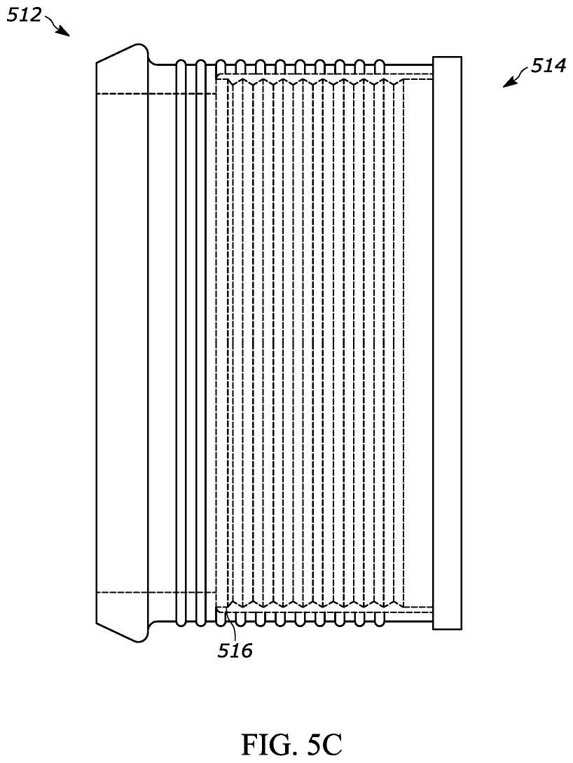

FIG. 5A is a diagram illustrating a tube hose 500 with injection molded hose ends in accordance with one or more embodiments.

The tube 500 includes a tube 110 and hose connections 108,508.

FIG. 5B is a diagram illustrating a portion of the tube hose 500 in accordance with one or more embodiments.

A hose end 508, 108 is shown. A first mating portion 514 is shown connected to the tube hose 110. The portion 514 has barbs on an exterior/outer surface.

A second mating portion 512 includes ridges or barbs on an interior surface and an exterior surface. The inner ridges or barbs mate/secure with the exterior bards on the 514 portion.

FIG. 5C is a diagram illustrating another portion of the tube hose 500 in accordance with one or more embodiments.

Here, the portions 514 and 512 are shown together and secured.

The piece 514 is an integrated portion of a Blow Molded duct. Piece 512 is the remainder of the spigot/hose connection, formed by the injection overmolding process.

It is appreciated that in one example, the portion/piece 514 is formed during the blow molding process (i.e., blow molding 320) and the portion/piece 512 is formed by injection molding/overmolding (i.e., injection molding 326). Thus, the hose connection 508, 108 is partially formed by blow molding and the remaining portion is formed by injection molding.

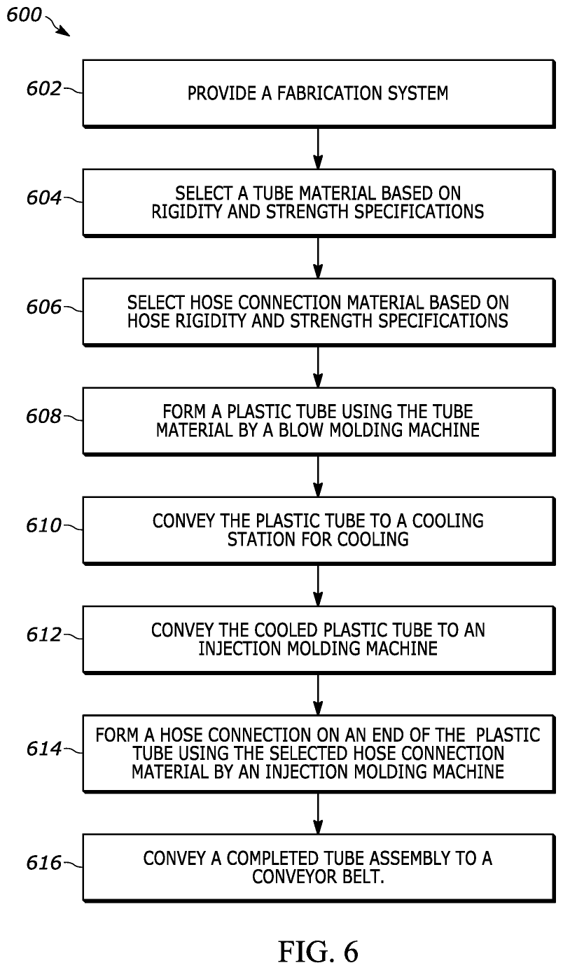

FIG. 6 is a flow diagram illustrating a method 600 of fabricating a tube assembly having integrated hose connections.

The method 600 begins at block 602, where a fabrication cell/system, such as the cell/system 300, is provided.

Tube material, including glass fiber percentage, is selected at block 604 based on rigidity and strength specifications or requirements.

Hose connection material, including glass fiber percentage, is selected at block 606 based on rigidity and strength specifications or requirements.

The blow molding machine 320 is configured to form the plastic tube 110 at block 608 using the selected tube material.

The robot 328 conveys the plastic tube 110 to a cooling station at block 510 to cool the plastic tube 110.

The robot 328 conveys the cooled plastic tube 110 to the injection molding machine 326 at block 612.

The injection molding machine 326 is configured to use injection molding, the selected hose connection material and the two cavity mold 400 to form one or more hose connections 108 to the plastic tube 110 at block 614.

The robot 328 conveys a completed assembly 200 comprising the plastic tube 110 and the one or more hose connections 108 to the conveyor belt 318.

It is appreciated that suitable variations of the method 500 are contemplated, including additional blocks and/or omission of shown blocks.

It should be added that ‘having’ does not exclude other elements or steps and ‘one’ or ‘one’ does not exclude a multitude. It should also be noted that characteristics described with reference to one of the above examples of execution can also be used in combination with other characteristics of other examples of execution described above. Reference signs in the claims are not to be regarded as a restriction.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus, system, and the like to perform the actions.

One general aspect includes a hose cell assembly system for fabricating hoses with integrated hose connections. The hose cell assembly system also includes an injection mold; and an injection molding machine configured to form an integrated hose connection onto an end of a plastic tubing using an injection molding process using the injection mold, where the plastic tubing is formed by a blow molding process.

Implementations may include one or more of the following features. The system may include: a blow molding machine configured to form the plastic tubing from a plastic material using the blow molding process. The system may include a conveyance robot configured to move the plastic tubing from the blow molding machine to the injection molding machine. The blow molding machine is configured to partially form the integrated hose connection using blow molding and the injection molding machine is configured to finish forming the integrated hose connection using injection molding. The injection mold is a two cavity injection mold used by the injection molding machine to form the integrated hose connection. The injection molding machine is further configured to process two parts at a time using a musical chair process to form the integrated hose connection. The system may include a blow molding mold used by a blow molding machine to form the plastic tubing. The system may include circuitry configured to select a plastic tube material based on plastic tube specifications and to select a hose connection material based on hose connection specifications. The hose connection material has more glass fiber than the plastic tube material. The hose connection specifications include a strength requirement. The system may include a conveyor belt for transporting the integrated hose connection and the plastic tubing after completion of the injection molding process. The hose connection may include a barbed profile. The system may include a cooling station configured to secure and cool the plastic tubing from the blow molding machine. Implementations of the described techniques may include hardware, a method or process, or computer software on a computer-accessible medium.

One general aspect includes an integrated hose connection and tube assembly. The integrated hose connection also includes a plastic tube formed by a blow molding process; and an integrated hose connection formed on an end of the plastic tube by an injection molding process.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A hose cell assembly system for fabricating hoses with integrated hose connections, the cell assembly comprising:
an injection mold; and
an injection molding machine configured to form an integrated hose connection onto an end of a plastic tubing using an injection molding process using the injection mold, wherein the plastic tubing is formed by a blow molding process.

2. The system of claim 1, further comprising:
a blow molding machine configured to form the plastic tubing from a plastic material using the blow molding process.

3. The system of claim 1, wherein the injection mold is a two cavity injection mold used by the injection molding machine to form the integrated hose connection.

4. The system of claim 2, further comprising a conveyance robot configured to move the plastic tubing from the blow molding machine to the injection molding machine.

5. The system of claim 1, wherein the injection molding machine is further configured to process two parts at a time using a musical chair process to form the integrated hose connection.

6. The system of claim 1, further comprising a blow molding mold used by a blow molding machine to form the plastic tubing.

7. The system of claim 1, further comprising circuitry configured to select a plastic tube material based on plastic tube specifications and to select a hose connection material based on hose connection specifications.

8. The system of claim 7, wherein the hose connection material has more glass fiber than the plastic tube material.

9. The system of claim 8, wherein the hose connection specifications include a strength requirement.

10. The system of claim 1, further comprising a conveyor belt for transporting the integrated hose connection and the plastic tubing after completion of the injection molding process.

11. The system of claim 1, wherein the hose connection comprises a barbed profile.

12. The system of claim 2, wherein the blow molding machine is configured to partially form the integrated hose connection using blow molding and the injection molding machine is configured to finish forming the integrated hose connection using injection molding.

13. The system of claim 1, further comprising a cooling station configured to secure and cool the plastic tubing from the blow molding machine.

14. An integrated hose connection and tube assembly comprising:
a plastic tube formed by a blow molding process; and
an integrated hose connection formed on an end of the plastic tube by an injection molding process.

15. The assembly of claim 14, wherein the integrated hose connection is also partially formed by the blow molding process,

16. The assembly of claim 14, wherein the integrated hose connection has a higher percentage of glass fiber than the plastic tube.

17. A method of fabricating a tube assembly having integrated hose connections, the method comprising:
providing a fabrication system or cell;
selecting a tube material based on rigidity and strength specifications;
selecting a hose connection material based on hose rigidity and strength specifications;
forming a plastic tube using the tube material by a blow molding machine;
conveying the cooled plastic tube to an injection molding machine;
forming a hose connection on an end of the plastic tube using the selected hose connection material by an injection molding machine.

18. The method of claim 17, wherein the hose connection material has a higher percentage of glass fiber than the tube material.

19. the method of claim 17, further comprising conveying the plastic tube to a cooling station for cooling after forming the plastic tube.

20. The method of claim 19, further comprising conveying the cooled plastic tube to an injection molding machine.
